(19) United States
(12) Patent Application Publication
(10) Pub. No.: US 2007/0234199 A1
(43) Pub. Date: Oct. 4, 2007

(54) Apparatus and method for compact representation of XML documents

(76) Inventor: Yevgeniy M. Astigeyevich, Novosibirsk (RU)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/394,711

(22) Filed: Mar. 31, 2006

(51) Int. Cl. G06F 15/00

(52) U.S. Cl. 715/513

(57) ABSTRACT

A method and apparatus for compact representation of extensible mark-up language (XML) documents are described. In one embodiment, the method includes the providing of XML document data of an input XML document to a document parser. In response to document events received from the document parser during parsing of the XML document data, an intermediate representation is generated from such event. During generation of the intermediate representation, in one embodiment, components of the XML document are compressed according to a predetermined format to form a compact, intermediate representation of the XML document. In one embodiment, the intermediate representation provides access to parsed content of the input XML document to enable, for example, a deferred document object model (DOM) document. Other embodiments are described and claimed.

### FIELD

One or more embodiments relate generally to the field of document parsers for extensible mark-up language (XML) documents. More particularly, one or more of the embodiments relate to a method and apparatus for compact representation of XML documents.

### BACKGROUND

Hypertext mark-up language (HTML) is a presentation mark-up language for displaying interactive data in a web browser. However, HTML is a rigidly-defined language and cannot support all enterprise data types. As a result of such shortcomings, HTML provided the impetus to create the extensible mark-up language (XML). The XML standard allows an enterprise to define its mark-up languages with emphasis on specific tasks, such as electronic commerce, supply chain integration, data management and publishing.

XML, a subset of the standard generalized mark-up language (SGML), is the universal format for data on the worldwide web. Using XML, users can create customized tags, enabling the definition, transmission, validation and interpretation of data between applications and between individuals or groups of individuals. XML is a complementary format to HTML and is similar to HTML as both contain mark-up symbols to describe the contents of a document. A difference, however, is that HTML is primarily designed to specify the interaction and display text and graphic images of a web page. XML does not have a specific application and can be designed for a wide variety of applications.

For these reasons, XML is rapidly becoming the strategic instrument for defining corporate data across a number of application domains. The properties of XML make it suitable for representing data, concepts and context in an open, vender and language neutral manner. XML uses tags, such as, for example, identifiers that signal the start and end of a related block of data, to recreate a hierarchy of related data components called elements. In turn, this hierarchy of elements provides context (implied meaning based on location) and encapsulation. As a result, there is a greater opportunity to reuse this data outside the application and data sources from which it was derived.

SAX (simple application programming interface (API)) for XML, is the most commonly used API to event-used parser. The SAX parser reads the XAL document incrementally, calling certain call-back functions in the application code whenever it recognizes a token. Call-back events are generated for the beginning and end of a document, the beginning and end of an element, etc. The SAX parser may populate an event queue with detected SAX events to enable certain call-back functions in the user application code whenever a recognized token is detected.

As XML documents represent a hierarchy of data, XML documents are generally recognized as having a tree structure. Consequently, representation of an XML document may be performed by using general tree data structures. Implementations of such representations are based on general tree data structures, which do not take into account specifics of XML documents. Unfortunately, representation of an XML document using a tree of objects requires a significant amount of memory. In some cases, such representations of an XML document may be five times the size of a parsed XML document. Although there are tree representations that use less memory than general tree representations, an additional amount of time is required for constructing the non-generalized representations.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a computer system including an extensible mark-up language (XML) processor including intermediate document builder logic for providing a compact representation of an input XML document, according to one embodiment.

FIG. 2 is a block diagram further illustrating the intermediate document builder logic of FIG. 1, according to one embodiment.

FIG. 3 is a structural diagram of the compact XML document representation, according to one embodiment.

FIG. 4 is a block diagram illustrating arrays representing an input XML document to provide a compact representation thereof, according to one embodiment.

FIG. 5 is a block diagram illustrating deferred document creation logic to provide a document object model (DOM) document where generation of DOM nodes is deferred and performed according to the compact, intermediate representation of an input XML document, according to one embodiment.

FIG. 6 is a block diagram further illustrating deferred DOM document builder logic of FIG. 5, according to one embodiment.

FIG. 7 is a flowchart illustrating a method for generating a deferred document object model (DOM) document using the compact, intermediate representation of an input XML document, according to one embodiment.

FIG. 8 is a flowchart illustrating a method for providing a compact, intermediate representation of an input XML document, according to one embodiment.

FIG. 9 is a block diagram illustrating various design representations or formulations for simulation, emulation and fabrication of a design using the disclosed techniques.

### DETAILED DESCRIPTION

A method and apparatus for compact representation of extensible mark-up language (XML) documents are described. In one embodiment, the method includes the providing of XML document data of an input XML document to a document parser. In response to document events received from the document parser during parsing of the XML document data, an intermediate representation is generated from such event. During generation of the intermediate representation, in one embodiment, components of the XML document are compressed according to a predetermined format to form a compact, intermediate representation of the XML document. In one embodiment, the intermediate representation provides access to parsed content of the input XML document to enable, for example, a deferred document object model (DOM) document.

In the following description, numerous specific details such as logic implementations, sizes and names of signals and buses, types and interrelationships of system components, and logic partitioning/integration choices are set forth in order to provide a more thorough understanding. It will be appreciated, however, by one skilled in the art that the invention may be practiced without such specific details. In other instances, control structures and gate level circuits have not been shown in detail to avoid obscuring the invention. Those of ordinary skill in the art, with the included descriptions, will be able to implement appropriate logic circuits without undue experimentation.

In the following description, certain terminology is used to describe features of the invention. For example, the term “logic” is representative of hardware and/or software configured to perform one or more functions. For instance, examples of “hardware” include, but are not limited or restricted to, an integrated circuit, a finite state machine or even combinatorial logic. The integrated circuit may take the form of a processor such as a microprocessor, application specific integrated circuit, a digital signal processor, a micro-controller, or the like.

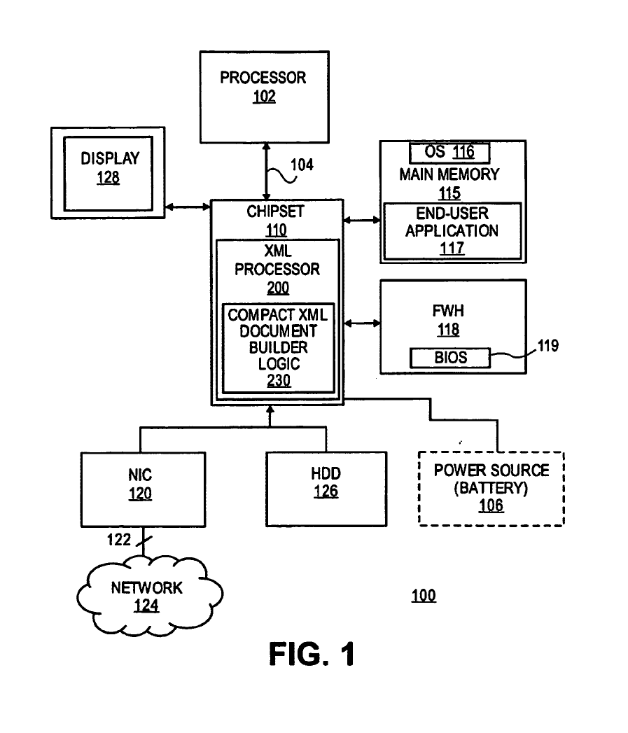

FIG. 1 is a block diagram illustrating computer system 100 including an extensible mark-up language (XML) processor 200 having intermediate document builder logic 230 to provide a compact representation of input XML documents, according to one embodiment. In one embodiment, computer system 100 may be a mobile personal computer (MPC) system. As described herein, MPC systems may include, but are not limited to laptop computers, notebook computers, handheld devices (e.g., personal digital assistants, cell phones, etc.) or other like battery powered devices.

Representatively, system 100 comprises interconnect 104 for communicating information between processor (CPU) 102 and chipset 110. In one embodiment, CPU 102 may be a multi-core processor to provide a symmetric multiprocessor system (SMP). As described herein, the term “chipset” is used in a manner to collectively describe the various devices coupled to CPU 102 to perform desired system functionality.

Representatively, display 128, network interface controller (NIC) 120, hard drive devices (HDD) 126, main memory 115, optional power source (battery) 106 and firmware hub (FWH) 118 may be coupled to chipset 110. In one embodiment, chipset 110 is configured to include a memory controller hub (MCH) and/or an input/output (I/O) controller hub (ICH) to communicate with I/O devices, such as NIC 120. In an alternate embodiment, chipset 110 is or may be configured to incorporate a graphics controller and operate as a graphics memory controller hub (GMCH). In one embodiment, chipset 110 may be incorporated into CPU 102 to provide a system on chip.

In one embodiment, main memory 115 may include, but is not limited to, random access memory (RAM), dynamic RAM (DRAM), static RAM (SRAM), synchronous DRAM (SDRAM), double data rate (DDR) SDRAM (DDR-SDRAM), Rambus DRAM (RDRAM) or any device capable of supporting high-speed buffering of data. Representatively, computer system 100 further includes non-volatile (e.g., Flash) memory 118. In one embodiment, flash memory 118 may be referred to as a “firmware hub” or FWH, which may include a basic input/output system (BIOS) 119 that is modified to perform, in addition to initialization of computer system 100, initialization of XML processor 200 and intermediate document builder logic 230 for providing a compact representation of an input XML document, according to one embodiment.

As further illustrated in FIG. 1, network interface controller (NIC) 120 may couple network 124 to chipset 110. In the embodiments described, network 124 may include, but is not limited to, a local area network (LAN), a metropolitan area network (MAN), a wide area network (WAN), a wireless network including a wireless LAN (WLAN), a wireless MAN (WMAN), a wireless WAN (WWAN) or other like network. Accordingly, in the embodiments described, NIC 120 may provide access to either a wired or wireless network. It should be recognized in the embodiments described, NIC 120 may be incorporated within chipset 110.

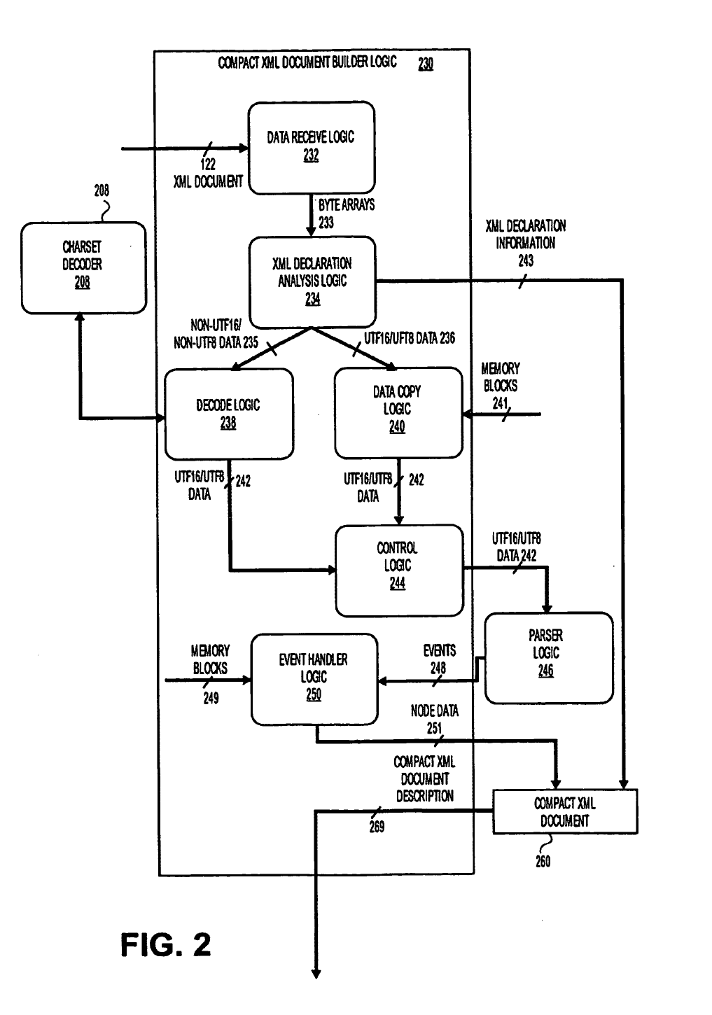

In one embodiment, NIC 120 may receive an input XML document 122 from network 124. In one embodiment, intermediate document builder logic 230 may provide a compact representation for access to parsed content of input XML document 122, according to one embodiment, as shown in FIG. 2.

FIG. 2 is a block diagram further illustrating intermediate document builder logic 230 of FIG. 1, according to one embodiment. Representatively, intermediate document builder logic includes data receive logic 232 to receive arrays and their descriptions 231. In one embodiment, array 231 contains data regarding an input XML document 122 (FIG. 1). In one embodiment, data receive logic 232 acquires pointers to arrays 231, as well as the lengths of arrays 231. In one embodiment, arrays 231 may be Java arrays, such that pointers for the primitive of arrays 232 may be acquired using the JNI_GetPrimitiveArrayCritical. As further shown in FIG. 2, primitive arrays 233 are provided to encode detect logic 234.

In one encode, detect logic 234 detects the data encoding and checks whether the encoding is in compliance with, for example, 16-bit Unicode Transformation format (UTF-16) encoding. When such encoding is detected, UTF-16 data 236 is provided to data copy logic 234. However, when non-UTF-16 data 235 is detected, such data 235 is provided to decode logic 238, which in combination with character set decode logic 208 decodes the data into UTF-16 format. In one embodiment, decode logic 238 may release the primitive arrays. For example, assuming the primitive arrays are Java arrays, the JNI_ReleasePrimitiveArrayCritical method may be used to perform such functionality. For UTF-16 data 236, there may be a requirement to make a data copy and release the primitive arrays. Accordingly, in one embodiment, data copy logic 240 copies the data within memory blocks 241 and release the primitive arrays using the release method.

Referring again to FIG. 2, in one embodiment, control logic 244 receives UTF-16 data 242 and sends data 242 to parser logic 246. In one embodiment, parser logic is an event-based parser which supports a simple application programming interface (API) for XML (SAX). Accordingly, in response to parsing an input XML document, parser logic 246 generate document SAX events 248, which are provided to event handler logic 250. In one embodiment, event handler logic 250, in response to receipt of such events, creates node data 251 to enable generation of intermediate document 260 to provide a compact representation for access to parsed content of an input XML document. Subsequently, an intermediate document description 269 may be provided to, for example, a document builder.

In one embodiment, intermediate document builder logic 230 receives an XML document, which is read into arrays 231. As shown, event handler logic 250 processes document events 248 into nodes of intermediate document 260. In one embodiment, data of intermediate document 260 is stored in arrays to improve performance of data copying from native code to non-native code, such as, for example, Java code as the non-native code. In one embodiment, character data of the intermediate document is in a UTF-16 encoding to avoid decoding data into UTF-16 during creation of, for example, string objects in non-native code, such as Java code.

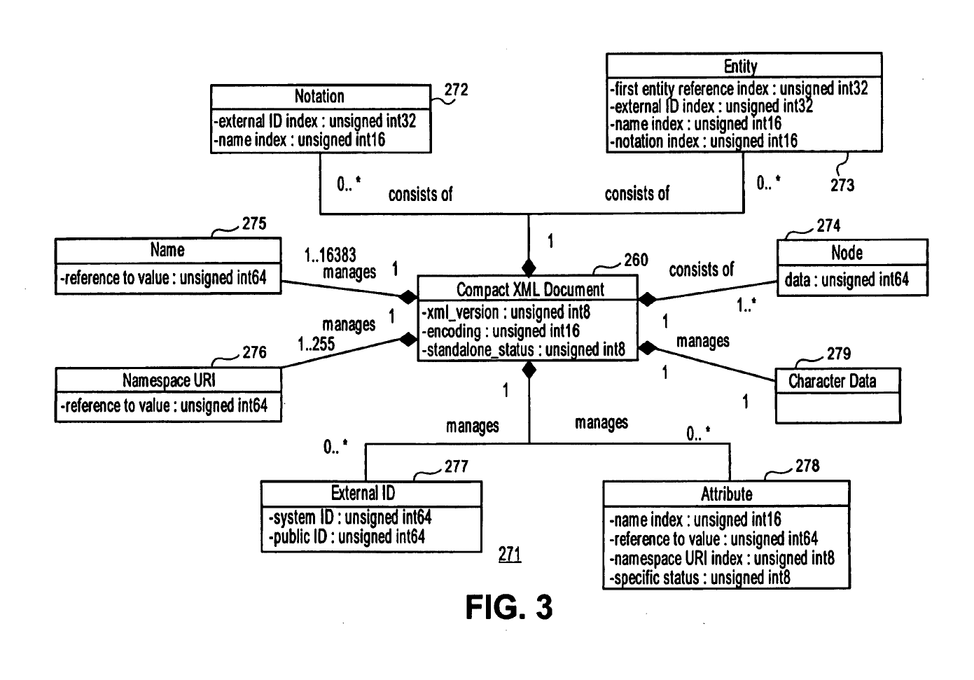

As described in further detail below, a description of the intermediate document 269 may be sent to a deferred document object model (DOM) document builder after the XML document has been parsed by parser logic 246. In one embodiment, data of intermediate document 260 is converted from a native format into a non-native format, such as Java primitive types (ints, longs, chars, etc.) and the data is stored into non-native arrays of the primitive types. The functionality performed by event handler logic 250 to generate node data 251 of intermediate document 260 provides a unique representation of an XML document, for example, as shown in FIG. 3.

FIG. 3 is a structural diagram 271 for the compact XML document representation, according to one embodiment. Representatively, FIG. 3 illustrates structural diagram 271, which describes features of the compact XML document representation, according to one embodiment. Representatively, a document 122 may consist of nodes 274 (elements, text, CDATA sections, comments, processing instructions, a document-type definition (DTD), entity references), entities 273 and notations 272. Document 122 may also control character data of an input XML document, names, namespace uniform resource identifiers (URIs), external IDs and attributes of elements, which are used in XML document 122.

In one embodiment, External ID 277 represents external IDs of entities, notations and DTD. External IDs 277 can consist of a system ID or public ID, or both system and public IDs. Character data 279 may include data used in XML document 122, such as symbols of names, characters of text, etc. Name 275 may represent names of elements, attributes, notations, DTD, entities, entity references and processing instructions. Namespace URI 276 may represent URIs used in the namespace declarations. In one embodiment, the XML version of the document is encoded into an unsigned eight-bit integer. First four bits of the integer specify a major revision number and the second four bits specify a minor revision number. In one embodiment, the character encoding of an XML document is identified by an management information base (MIB) enumeration (MIBenum) value, which can be found in the Internet Assigned Numbers Authority (IANA) Charset Registry and the MIBenum value may be stored as an unsigned 16-bit integer. In one embodiment, the standalone status of the document is represented by 0 and 1; 0 may mean the document is not a standalone document, 1 may mean the document is a standalone document. However, it should be recognized that other status encoding are possible. The values may be stored into an unsigned 8 bit integer.

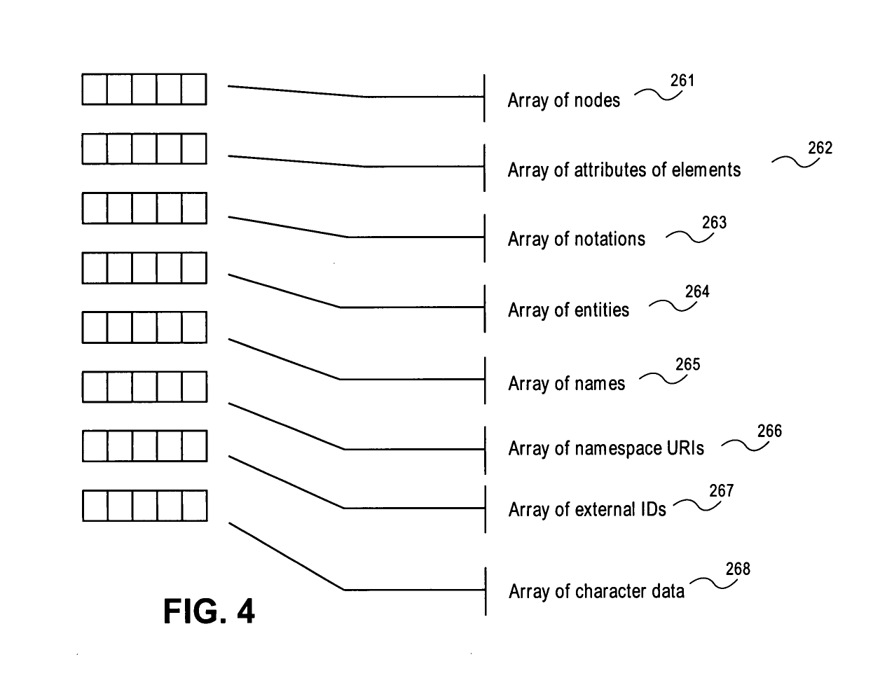

FIG. 4 is a block diagram illustrating arrays representing an XML document 122 (FIG. 1), according to one embodiment. In one embodiment, an XML document (122) is represented using array of nodes 261, array of attributes 262, array of notations, 263, array of entities 264, array of names 265, array of namespace URIs 266, array of external IDs 267 and array of character data 268. In one embodiment, data of elements, text, CDATA sections, comments, processing instructions, DTD, and entity references and relations among them are packed and placed into array of nodes 261.

In one embodiment, a next sibling of text, CDATA sections, comments, processing instructions and DTD follows a sibling in the array of nodes 261. As elements and entity references can have children, in one embodiment, indices of their next siblings are stored. In one embodiment, the first child of an entity reference and an element follows its parents.

The following tables (Table 1 and Table 2) illustrate algorithms for obtaining a next sibling and a first child. Table 1 illustrates one embodiment of a Next Sibling Algorithm. Table 2 illustrates one embodiment of a First Child Algorithm.

TABLE 1
Next Sibling Algorithm

```
Input: node_index
Output: next_sibling_index {0xffffffff means that a node does not have
the next sibling}
if has_next_sibling(node_index) = TRUE then
    ;; element nodes have type 0, entity reference nodes have type 6
    if node_type(node_index) = 0 OR node_type(node_index) = 6
then
        next_sibling_index =
        extract_next_sibling_index(nodes[node_index1);
    else
        next_sibling_index = node_index + 1;
    end if
    else
        next_sibling_index = 0xffffffff
end if
```

TABLE 2
First Child Algorithm

```
Input: node_index
Output: first_child_index {0xffffffff means that a node does not
have children}
;; element nodes have type 0, entity reference nodes have type 6
if (node_type(node_index) = 0 OR node_type(node_index) = 6) AND
has_children(node_index) = TRUE
then
    if node_type(node_index) = 0 AND has_attributes(node_index) =
    TRUE
    then
        first_child_index = node_index + 2; {16 bytes are
used to store information of elements with attributes}
    else
        first_child_index = node_index + 1;
    end if
else
    first_child_index = 0xffffffff;
end if
```

As shown in Tables 1 and 2, the node_type ( ) function may extract the first three bits of the node data and return an integer value. The has_next_sibling( ) function may return TRUE when a node has the next sibling (the bit 3 is checked) and FALSE otherwise. The extract_next_sibling_Index( ) may extract bits 32 . . . 63 of the data of the element and entity reference nodes and return an integer value. The has_children( ) function may return TRUE when an element node or an entity reference node has children (the bit 18 is checked) and FALSE otherwise. The has_attributes( ) function may return TRUE when an element node has attributes (the 19 bit is checked) and FALSE otherwise.

Referring again to FIG. 4, in one embodiment, the array of names 265 is used for storing names of elements, names of attributes, names of processing instructions, names of entities, names of entity references, names of notations and a name of DTD. The array of namespace URIs 266 may be used for storing uniform resource identifiers (URIs) of elements and attributes. The array of external IDs 267 may be used for storing external IDs of entities, notations and DTD. The array of character data 268 may be used for storing character data used in an XML document, such as symbols of names, characters of text, etc.

In one embodiment, elements are packed into either 8 bytes or 16 bytes. Text CDATA sections, comments, processing instructions, DTD and entity references may be packed/may be packed into 8 bytes. In one embodiment, the packing of such information may be performed according to a predetermined format, for example, as provided within Table 3, which illustrates a packed format for compact representation of an input XML document to provide access to parsed content of the input XML document.

```
TABLE 3
Element:
    Bits 0..2 are set to 000.
    Bit 3 specifies whether the element has the next sibling.
    Bits 4..17 specify the index of the element name id in the array of names.
    Bit 18 specifies whether the element has child nodes.
    Bit 19 specifies whether the element has attributes.
    Bits 20..27 specify the index of the namespace URI in the array of namespace
URIs if the element is bound to the certain namespace and otherwise they are set to 1.
    Bits 28..31 are reserved.
    Bits 32..63 specify the index of the next sibling node in the array of nodes if the
element has the next sibling and otherwise they are set to 1.
    Additional 8 bytes are used for attribute information:
        Bits 0..31 specify the number of attributes.
        Bits 32..63 specify the index of the first attribute in the array of attributes.
Text, CDATA section and Comment:
    Bits 0..2 are set to 001 for Text nodes, to 010 for CDATA section nodes and to
011 for Comment nodes.
    Bit 3 specifies whether the node has the next sibling.
    Bits 4..31 specify the length of the node content.
    Bits 32..61 specify the index of the content first character in the array of character
data.
    Bits 62..63 are reserved.
Processing instruction:
    Bits 0..2 are set to 100.
    Bit 3 specifies whether the node has the next sibling.
    Bits 4..17 specify the index of the target name in the array of names.
    Bits 18..33 specify the length of the node content if the processing instruction has
the content and otherwise they are set to 0.
    Bits 34..63 specify the index of the content first character in the array of character
data if the processing instruction has the content and otherwise they are set to 0.
DTD:
    Bits 0..2 are set to 101.
    Bit 3 specifies whether the node has the next sibling.
    Bits 4..17 specify the index of the DTD name in the array of names.
    Bits 18..31 are reserved
    Bits 32..63 specify the index of the external ID in the array of external IDs if DTD
has the external ID and otherwise they are set to 1.
Entity reference node: 64 bits
    Bits 0..2 are set to 110.
    Bit 3 specifies whether the node has the next sibling.
    Bits 4..17 specify the index of the entity reference name in the array of names.
    Bit 18 specifies whether the entity reference has child nodes.
    Bits 19..31 are reserved.
    Bits 32..63 specify the index of the next sibling node in the array of nodes if the
element has the next sibling and otherwise they are set to 1.
```

Nodes, attributes, external IDs, namespace URIs, names, notations, entities and character data may be stored into arrays and may be identified by an index. The arrays may consist of one chunk or several fixed-size chunks. In one embodiment, the array of character data consists of one chunk. In one embodiment, multi-chunk arrays include index construction algorithm and index resolution algorithm, as shown in Tables 4 and 5, respectively.

TABLE 4
Algorithm: Index construction
Input: an index of a chunk, an index of an element inside a chunk
Output: an index
index = index of chunk * size of chunk + index of element inside chunk

TABLE 5
Algorithm: Index resolution
Input: an index
Output: an index of a chunk, an index of an element inside a chunk
index of chunk = round( index / size of chunk )
index of element inside chunk = residue of division of index by size of
chunk

In one embodiment, restricting of data copied into character data array 268 may be performed as follows, which may be referred to herein as “condensing/compressing components” of an XML document. The following rules may define data copied into the character data array, according to one embodiment:

Data of a name may be copied if there is no such a name in the array of names.

Data of a namespace URI may be copied if there is no such a namespace URI in the array of namespace URIs.

Content of CDATA sections and processing instructions are copied.

Content of Text nodes is always copied excepting the following cases:
If Text node content consists of the space character (#x20) and the Text node with the same content occurred previously then a reference to the content of that previous node may be used.
If Text node content consists of the tab character (#x09) and the Text node with the same content occurred previously then a reference to the content of that previous node may be used.
If Text node content consists of the sequence of the characters carriage return and line feed (#x0D#0A) and the Text node with the same content occurred previously then a reference to the content of that previous node may be used.
If Text node content consists of the line feed character (#x0A) and the Text node with the same content occurred previously then a reference to the content of that previous node may be used.
If Text node content consists of the carriage return character ((#x0D) and the Text node with the same content occurred previously then a reference to the content of that previous node may be used.
If a Text node has content that matches to a user-specified template and the Text node with the same content occurred previously then a reference to the content of that previous node is used. In one embodiment, the template defines a unique sequence of characters.

Data of an external ID is copied if there is no such an external ID in the array of external IDs.

In one embodiment, an 8 bit index having a value 0xff, a 16 bit index having a value 0xffff and a 32 bit index having the value 0xffffffff may represent the NULL indices. In one embodiment, the NULL string may be represented by the 64 bit integer having the value 0.

In one embodiment, system ID and public ID are packed references to the strings representing those IDs, packed as follows:

First four bytes converted into an unsigned 32 bit integer specify the length of the string.

Second four bytes converted into an unsigned 32 bit integer specify the index of the string first character in the array of character data.

In one embodiment, for names, namespace URIs and attributes, the reference to the value is a packed reference to the string representing the corresponding value of the name, namespace URI and attribute. In one embodiment, the references are packed in the same way as the system ID and the public ID strings. In one embodiment, the specify status of an attribute is represented by 0 and 1; 0 may mean the attribute is not specified in the start-tag of its element, 1 may mean the attribute is specified; however, alternate settings are also possible. In one embodiment, the values are stored into an unsigned 8 bit integer.

In one embodiment, for a parsed entity, an index of its first entity reference node is stored to have an access to the parsed content of the entity. The content of parsed entities which are referenced may be stored in the representation. In the case of parsed entities, the notation index may be a NULL index. In a case of unparsed entities the first entity reference index may be NULL index. If no namespaces are used in an XML document, there is no the namespace URIs and all namespace URI indices are the NULL indices.

In one embodiment, an XML document should meet the following conditions to be represented by the intermediate document:
The summarized amount of all unique character data extracted from the XML document and decoded into the UTF-16 encoding should not be more than 2\textcircled{30} characters.
The number of names used in the document including names of elements, names of attributes, names of processing instructions, names of entities, names of notations and a name of DTD should not be more than 16383.
The number of namespace URIs should not be more than 255.
Processing instructions should a length of content that is not more than 65536.
Text, CDATA sections and comments should not have a length of content more than 2\textcircled{28} characters.

Referring again to FIG. 2, event handler logic 250 generates node data of an intermediate document according to received SAX events. The various SAX events may include, but are not limited to, a start element event, an end element event, an XML declaration event, a characters event, a comment event, a CDATA section event, a start DTD event, an end DTD event, a processing instruction event, a notation declaration event, an external parsed entity declaration event, an internal parsed entity declaration event, an unparsed entity declaration event, a start entity event and an end entity event.

Accordingly, in one embodiment, in response to receipt of one of the above-described SAX events, code may be generated to capture the data associated with the event to store the data within, for example, one of the arrays shown in FIG. 4. As shall be illustrated with references to Tables 6-20, Tables 6-20 illustrate pseudo-code for capturing data from an input XML document, according to detected events during parsing of the input XML document, according to one embodiment.

TABLE 6
Start Element Event

```
Event data (qname: the qualified name of the element, URI: the
element's namespace URI, Attributes: the element's attributes)
begin
  firstAttributeIndex [symbol] size of ARR_ATTRIBUTES
  foreach attribute in Attributes do
    name [symbol] Get the name of attribute
    namespaceURI [symbol] Get the namespace URI of attribute
    value [symbol] Get the value of attribute
    isSpecified [symbol] Was attribute explicitly specified in the start tag
    nameIndex [symbol] Look up name in ARR_NAMES
    if nameIndex = 0xffff then
      nameIndex [symbol] Add name to ARR_NAMES
    end if
    namespaceURIIndex [symbol] 0xffff
    if namespaceURI is not empty then
      namespaceURIIndex [symbol] Look up namespaceURI in
      ARR_NAMESPACE_URIS
      if namespaceURIIndex = 0xffff then
        namespaceIndex [symbol] Add namespaceURI to
        ARR_NAMESPACE_URIS
      end if
    end if
    unsigned int64 valueReference [symbol] 0
    valueIndex [symbol] Add value to ARR_CHARACTER_DATA
    Store the length of value into bits 0..31 of valueReference
    Store valueIndex into bits 32..63 of valueReference
    Add item (nameIndex, namespaceURIIndex, valueReference,
    isSpecified) to ARR_ATTRIBUTES
  end for
  qnameIndex [symbol] Look up qname in ARR_NAMES
  if qnameIndex = 0xffff then
    qnameIndex [symbol] Add qname to ARR_NAMES
  end if
  URIIndex [symbol] 0xffff
  if URI is not empty then
    URIIndex [symbol] Look up URI in ARR_NAMESPACE_URIS
      if URIIndex = 0xffff then
        URIIndex [symbol] Add URI in ARR_NAMESPACE_URIS
  end if
  end if
  unsigned int64 data [symbol] 0
  unsigned int64 attributeInformation [symbol] 0
  Store qnameIndex into bits 4..17 of data
  Store URIIndex into bits 20..27 of data
  if number of attributes is not zero then
    Set bit 19 of data to 1
    Store number of attributes into bits 0..31 of attributeInformation
    Store firstAttributeIndex into bits 32..63 of attributeInformation
  end if
  Set bits 32.63 of data to 1
  elementIndex [symbol] Add data to ARR_NODES
  if attributeInformation != 0 then
  Add attributeInformation to ARR_NODES
  end if
  if LAST_NODE_INDEX != 0xffffffff and LAST_EVENT !=
  START_ELEMENT and LAST_EVENT != START_ENTITY then
    Set bit 3 of data identified with LAST_NODE_INDEX in
  ARR_NODES to 1
      if LAST_EVENT = END_ELEMENT or LAST_EVENT =
    END_ENTITY then
        Store elementIndex into bits 32..63 of data identified with
      LAST_NODE_INDEX in ARR_NODES
      end if
    end if
    LAST_EVENT [symbol] START_ELEMENT
    Push elementIndex into STACK
  end.
```

TABLE 7
End Element Event

```
begin
        nodeIndex [symbol] Pop a value from STACK
        if LAST_EVENT != START_ELEMENT then
          Set bit 18 of data identified with nodeIndex in ARR_NODES
        end if
        LAST_EVENT [symbol] END_ELEMENT
        LAST_NODE_INDEX [symbol] nodeIndex
    end.
```

TABLE 8
XML Declaration Event

```
Event data (xmlVersion: the version of the XML specification,
encodingName: the document encoding, standalone: the
‘standalone’ attribute value)
begin
    Store the major version number of xmlVersion into bits 0..3 of
        Document.xml_version
    Store the minor version number of xmlVersion into bits 4..7 of
        Document.xml_version
    if encodingName is recognized then
    Document.encoding [symbol] Look up MIBEnum of encodingName
    end if
    if standalone = ‘yes’ then
Document.standalone_status [symbol] 1
    else
Document.standalone_status [symbol] 0
    end if
end.
```

TABLE 9
Characters Event

```
Event data (characters, length)
begin
    unsigned int64 data [symbol] 1
    if characters consists of the symbol 0x20 then
        if char0x20Index != 0xffffffff then
    charactersIndex [symbol] char0x20Index
    else
    charactersIndex [symbol] Add characters to ARR_CHARACTER_DATA
    char0x20Index [symbol] charactersIndex
    end if
    else if characters consists of the symbol 0x09 then
    if char0x09Index != 0xffffffff then
    charactersIndex [symbol] char0x09Index
    else
    charactersIndex [symbol] Add characters to ARR_CHARACTER_DATA
    char0x09Index [symbol] charactersIndex
    end if
    else if characters consists of the symbol 0x0A then
    if char0x0AIndex != 0xffffffff then
    charactersIndex [symbol] char0x0AIndex
    else
    charactersIndex [symbol] Add characters to ARR_CHARACTER_DATA
    char0x0AIndex [symbol] charactersIndex
    end if
    else if characters consists of the symbol 0x0D then
    if char0x0DIndex != 0xffffffff then
    charactersIndex [symbol] char0x0DIndex
    else
    charactersIndex [symbol] Add characters to ARR_CHARACTER_DATA
    char0x0DIndex [symbol] charactersIndex
    end if
    else if characters consists of the symbols 0x0D0x0A then
    if chars0x0D0x0AIndex != 0xffffffff then
    charactersIndex [symbol] chars0x0D0x0AIndex
    else
    charactersIndex [symbol] Add characters to ARR_CHARACTER_DATA
    chars0x0D0x0AIndex [symbol] charactersIndex
    end if
    else if characters matches to the user defined template then
    if userDefinedCharsIndex != 0xffffffff then
    charactersIndex [symbol] userDefinedCharsIndex
    else
    charactersIndex [symbol] Add characters to ARR_CHARACTER_DATA
    userDefinedCharsIndex [symbol] charactersIndex
    end if
    else
    charactersIndex [symbol] Add characters to ARR_CHARACTER_DATA
    end if
    Store length into bits 4..31 of data
    Store charactersIndex into bits 32..61 of data
    textNodeIndex [symbol] Add data to ARR_NODES
    if LAST_NODE_INDEX != 0xffffffff and LAST_EVENT !=
    START_ELEMENT and LAST_EVENT != START_ENTITY then
    Set bit 3 of data identified with LAST_NODE_INDEX in
    ARR_NODES to 1 if LAST_EVENT = END_ELEMENT
    or LAST_EVENT = END_ENTITY then Store textNodeIndex
    into bits 32..63 of data identified with LAST_NODE_INDEX
    in ARR_NODES
    end if
    end if
    LAST_EVENT [symbol] CHARACTERS
    LAST_NODE_INDEX [symbol] textNodeIndex
end.
```

TABLE 10
Comment Event

```
Event data (characters, length)
begin
    unsigned int64 data [symbol] 3
    charactersIndex [symbol] Add characters to ARR_CHARACTER_DATA
    Store length into bits 4..31 of data
    Store charactersIndex into bits 32..61 of data
    commentNodeIndex [symbol] Add data to ARR_NODES
    if LAST_NODE_INDEX != 0xffffffff and LAST_EVENT !=
    START_ELEMENT and LAST_EVENT != START_ENTITY then
    Set bit 3 of data identified with LAST_NODE_INDEX in
    ARR_NODES to 1 if LAST_EVENT = END_ELEMENT
    or LAST_EVENT = END_ENTITY then
    Store commentNodeIndex into bits 32..63 of data identified with
    LAST_NODE_INDEX in ARR_NODES
    end if
    end if
    LAST_EVENT [symbol] COMMENT
    LAST_NODE_INDEX [symbol] commentNodeIndex
end.
```

TABLE 11
CDATA Section Event

```
Event data (characters, length)
begin
    unsigned int64 data [symbol] 2
    charactersIndex [symbol] Add characters to ARR_CHARACTER_DATA
    Store length into bits 4..31 of data
    Store charactersIndex into bits 32..61 of data
    cdataNodeIndex [symbol] Add data to ARR_NODES
    if LAST_NODE_INDEX != 0xffffffff and LAST_EVENT !=
    START_ELEMENT and LAST_EVENT != START_ENTITY then
    Set bit 3 of data identified with LAST_NODE_INDEX in
    ARR_NODES to 1 if LAST_EVENT = END_ELEMENT
    or LAST_EVENT = END_ENTITY then Store cdataNodeIndex
    into bits 32..63 of data identified with
    LAST_NODE_INDEX in ARR_NODES
    end if
    end if
    LAST_EVENT [symbol] CDATA
    LAST_NODE_INDEX [symbol] cdataNodeIndex
  end.
```

TABLE 12
Start DTD Event

```
Event data (name, public Id, system Id)
begin
    unsigned int64 data [symbol] 5
    nameIndex [symbol] Look up name in ARR_NAMES
    if nameIndex = 0xffff then
    nameIndex [symbol] Add name to ARR_NAMES
    end if
    externalIdIndex [symbol] 0xffffffff
    if system Id is specified then
    externalIdIndex [symbol] Look up the external Id having the same public Id
    and system Id in ARR_EXTERNAL_IDS
    if externalIdIndex = 0xffffffff then
    unsigned int64 publicIdReference [symbol] 0
    unsigned int64 systemIdReference [symbol] 0
    if public Id is specified then
    publicIdIndex [symbol] Add public Id to ARR_CHARACTER_DATA
    Store the length of public Id into bits 0..31 of publicIdReference
    Store publicIdIndex into bits 32..63 of publicIdReference
    end if
    systemIdIndex [symbol] Add system Id to ARR_CHARACTER_DATA
    Store the length of system Id into bits 0..31 of systemIdReference
    Store systemIdIndex into bits 32..63 of systemIdReference
    Add the external Id (systemIdReference, publicIdReference) to
    ARR_EXTERNAL_IDS
    end if
    end if
    Store nameIndex into bits 4..17 of data
    Store externalIdIndex into bits 32..63 of data
    dtdNodeIndex [symbol] Add data to ARR_NODES
    if LAST_NODE_INDEX != 0xffffffff and LAST_EVENT !=
    START_ELEMENT and LAST_EVENT != START_ENTITY then
    Set bit 3 of data identified with LAST_NODE_INDEX in
    ARR_NODES to 1 if LAST_EVENT = END_ELEMENT
    or LAST_EVENT = END_ENTITY then
    Store dtdNodeIndex into bits 32..63 of data identified with
    LAST_NODE_INDEX
    in ARR_NODES
    end if
    end if
    LAST_EVENT [symbol] DTD
    LAST_NODE_INDEX [symbol] dtdNodeIndex
    Turn off receiving comment and processing instruction events
end.
```

TABLE 13
End DTD Event

begin
Turn on receiving comment and processing instruction events
end.

TABLE 14
Processing Instruction Event

```
Event data (target, data)
begin
    unsigned int64 nodeData [symbol] 4
    targetIndex [symbol] Look up target in ARR_NAMES
    if targetIndex = 0xffff then
    targetIndex [symbol] Add target to ARR_NAMES
    end if
    Store targetIndex into bits 4..17 of nodeData
    if data is specified then
    dataIndex [symbol] Add data to ARR_CHARACTER_DATA
    Store the length of data into bits 18..33 of nodeData
    Store dataIndex into bits 34..63 of nodeData
    end if
    piNodeIndex [symbol] Add nodeData to ARR_NODES
    if LAST_NODE_INDEX != 0xffffffff and LAST_EVENT !=
    START_ELEMENT and LAST_EVENT != START_ENTITY then
    Set bit 3 of data identified with LAST_NODE_INDEX in
    ARR_NODES to 1 if LAST_EVENT = END_ELEMENT
    or LAST_EVENT = END_ENTITY then
    Store piNodeIndex into bits 32..63 of data identified with
    LAST_NODE_INDEX in ARR_NODES
    end if
    end if
    LAST_EVENT [symbol] PROCESSING_INSTRUCTION
    LAST_NODE_INDEX [symbol] piNodeIndex
end.
```

TABLE 15
Notation Declaration Event

```
Event data (name, public Id, system Id)
begin
    nameIndex [symbol] Look up name in ARR_NAMES
    if nameIndex = 0xffff then
    nameIndex [symbol] Add name to ARR_NAMES
    end if
    externalIdIndex [symbol] Look up the external Id having the same public Id
    and system Id in ARR_EXTERNAL_IDS
    if externalIdIndex = 0xffffffff then
    unsigned int64 publicIdReference [symbol] 0
    unsigned int64 systemIdReference [symbol] 0
    if public Id is specified then
    publicIdIndex [symbol] Add public Id to ARR_CHARACTER_DATA
    Store the length of public Id into bits 0..31 of publicIdReference
    Store publicIdIndex into bits 32..63 of publicIdReference
    end if
    if system Id is specified then
    systemIdIndex [symbol] Add system Id to ARR_CHARACTER_DATA
    Store the length of system Id into bits 0..31 of systemIdReference
    Store systemIdIndex into bits 32..63 of systemIdReference
    end if
    externalIdIndex [symbol] Add the external Id (systemIdReference,
    publicIdReference)
    to ARR_EXTERNAL_IDS
    end if
    Add the notation (nameIndex, externalIdIndex) to
    ARR_NOTATIONS
end.
```

TABLE 16
External Parsed Entity Declaration Event

```
Event data (name, public Id, system Id)
begin
    nameIndex [symbol] Look up name in ARR_NAMES
    if nameIndex = 0xffff then
    nameIndex [symbol] Add name to ARR_NAMES
    end if
    externalIdIndex [symbol] Look up the external Id having the same public Id
    and system Id in ARR_EXTERNAL_IDS
    if externalIdIndex = 0xffffffff then
    unsigned int64 publicIdReference [symbol] 0
    unsigned int64 systemIdReference [symbol] 0
    if public Id is specified then
    publicIdIndex [symbol] Add public Id to ARR_CHARACTER_DATA
    Store the length of public Id into bits 0..31 of publicIdReference
    Store publicIdIndex into bits 32..63 of publicIdReference
    end if
    systemIdIndex [symbol] Add system Id to ARR_CHARACTER_DATA
    Store the length of system Id into bits 0..31 of systemIdReference
    Store systemIdIndex into bits 32..63 of systemIdReference
    externalIdIndex [symbol] Add the external Id (systemIdReference,
    publicIdReference) to ARR_EXTERNAL_IDS
    end if
    Add the entity (0xffffffff, externalIdIndex, nameIndex, 0xffff) to
    ARR_ENTITIES
end.
```

TABLE 17
Internal Parsed Entity Declaration Event

```
Event data (name)
begin
    nameIndex [symbol] Look up name in ARR_NAMES
    if nameIndex = 0xffff then
    nameIndex [symbol] Add name to ARR_NAMES
    end if
    Add the entity (0xffffffff, 0xffffffff, nameIndex, 0xffff) to
    ARR_ENTITIES
end.
```

TABLE 18
Unparsed Entity Declaration Event

```
Event data (name, public Id, system Id, notation name)
begin
    nameIndex [symbol] Look up name in ARR_NAMES
    if nameIndex = 0xffff then
    nameIndex [symbol] Add name to ARR_NAMES
    end if
    externalIdIndex [symbol] Look up the external Id having the same public Id
    and system Id in ARR_EXTERNAL_IDS
    if externalIdIndex = 0xffffffff then
    unsigned int64 publicIdReference [symbol] 0
    unsigned int64 systemIdReference [symbol] 0
    if public Id is specified then
    publicIdIndex [symbol] Add public Id to ARR_CHARACTER_DATA
    Store the length of public Id into bits 0..31 of publicIdReference
    Store publicIdIndex into bits 32..63 of publicIdReference
    end if
    systemIdIndex [symbol] Add system Id to ARR_CHARACTER_DATA
    Store the length of system Id into bits 0..31 of systemIdReference
    Store systemIdIndex into bits 32..63 of systemIdReference
    externalIdIndex [symbol] Add the external Id (systemIdReference,
    publicIdReference) to ARR_EXTERNAL_IDS
    end if
    notationNameIndex [symbol] Look up notation name in ARR_NAMES
    if notationNameIndex = 0xffff then
    notationNameIndex [symbol] Add notation name to ARR_NAMES
    end if
    Add the entity (0xffffffff, externalIdIndex, nameIndex,
    notatioNameIndex) to ARR_ENTITIES
end.
```

TABLE 19
Start Entity Event

```
Event data (name)
begin
    if it is predefined entity then
    goto end.
    end if
    unsigned int64 data [symbol] 6
    nameIndex [symbol] Look up name in ARR_NAMES
    if nameIndex = 0xffff then
    nameIndex [symbol] Add name to ARR_NAMES
    end if
    Store nameIndex into bits 4..17 of data
    Set bits 32..63 of data to 1
    entityReferenceNodeIndex [symbol] Add data to ARR_NODES
    entityDeclIndex [symbol] Get an index of the entity declaration with
    nameIndex if the entity identified with entityDeclIndex has first
    entity reference index = 0xffffffff then
    first entity reference index [symbol] entityReferenceNodeIndex
    end if
    if LAST_NODE_INDEX != 0xffffffff and LAST_EVENT !=
    START_ELEMENT and LAST_EVENT != START_ENTITY then
    Set bit 3 of data identified with LAST_NODE_INDEX in
    ARR_NODES to 1 if LAST_EVENT = END_ELEMENT
    or LAST_EVENT = END_ENTITY then
    Store entityReferenceNodeIndex into bits 32..63 of data identified
    with LAST_NODE_INDEX in ARR_NODES
    end if
    end if
    LAST_EVENT [symbol] START_ENTITY
    Push entityReferenceNodeIndex into STACK
end.
```

TABLE 20
End Entity Event

```
begin
    if it is predefined entity then
    goto end.
    end if
    nodeIndex [symbol] Pop a value from STACK
    if LAST_EVENT != START_ENTITY then
    Set bit 18 of data identified with nodeIndex in ARR_NODES
    end if
    LAST_EVENT [symbol] END_ENTITY
    LAST_NODE_INDEX [symbol] nodeIndex
end.
```

Accordingly, Tables 6-20 illustrate pseudo-code for generating of the intermediate representation based on detected events. Representatively, a compact representation of an input XML document is generated in response to document events, as indicated by start element event table (TABLE 6), end element event table (TABLE 7), XML declaration event table (TABLE 8), characters event table (TABLE 9), comment event table (TABLE 10), CDATA section event table (TABLE 11), start DTD event table (TABLE 12) and end DTD event table (TABLE 13), processing instruction table (TABLE 14), notation declaration event table (TABLE 15), external parsed entity declaration event table (TABLE 16), internal parsed entity declaration event table (TABLE 17), unparsed entity declaration event table (TABLE 18), start entity event table (TABLE 19) and end entity event table (TABLE 20).

In the pseudo-code provided in Tables 6-20, the 8 arrays described with reference to FIG. 4 are used according to the following naming convention: ARR_ATTRIBUTES 262; ARR_NAMES 265; ARR_NAMESPACE_URIS 266; ARR_CHARACTER_DATA 268; ARR_NODES 261; ARR_EXTERNAL IDS 267; ARR_NOTATIONS 263; and ARR_ENTITIES 264. As further described in the pseudo-code illustrated in Tables 6-20, a stack may be used for storing of indices of elements and entity reference nodes in ARR_NODES 261. As further described, LAST_EVENT may specify the last occurred event, whereas LAST_NODE_INDEX may represent an index of the last added node in ARR_NODES 261. In addition, the following notation may also be used:

Document: a global structure which holds all arrays and additional
information
char0x20Index: an index of the character ‘0x20’ in
ARR_CHARACTER_DATA
char0x09Index: an index of the character ‘0x09’ in
ARR_CHARACTER_DATA
char0x0AIndex: an index of the character ‘0x0A’ in
ARR_CHARACTER_DATA
char0x0DIndex: an index of the character ‘0x0D’ in
ARR_CHARACTER_DATA
chars0x0D0x0AIndex: an index of the first character of “0x0D0x0A” in
ARR_CHARACTER_DATA
userDefinedCharsIndex: an index of the first character of the user defined
string in ARR_CHARACTER_DATA

As further illustrated with reference to Tables 6-20, comments and process instructions inside DTDs are ignored. In addition, in one embodiment, references in the pseudo-code to storing an integer value in k bits may mean that the first k bits of the value are stored into the destination bits.

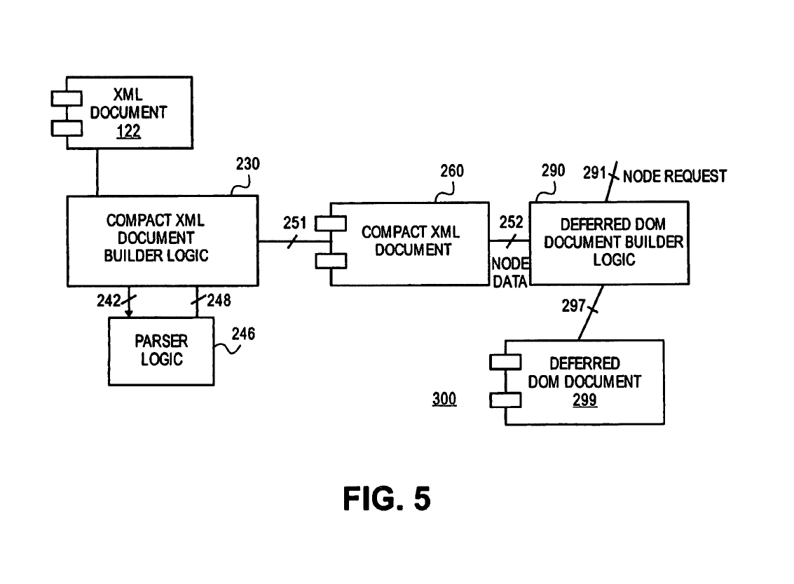

FIG. 5 is a block diagram illustrating one embodiment of intermediate document 260, which is generated by intermediate document builder logic 230 (using parser logic 246) for according to, for example, the pseudo-code provided in Tables 6-20, may be provided as an intermediate representation 260 of input XML document 122 for a deferred document object model (DOM) document 299. As described herein, a deferred DOM document means that nodes of the DOM document are created when they are accessed. Accordingly, in one embodiment, for example, as shown in FIG. 5, instead of building all nodes, as generally performed to build a DOM document, a few nodes are generated to provide a deferred DOM document 299.

Representatively, input XML document 122 is parsed into an intermediate document 260 using, for example, the compact representation, as described above, and a deferred DOM document 299 with a minimum number of nodes is created. The structure of the intermediate document should be simple and data of a node should be obtained quickly. In one embodiment, when a particular node of the DOM document, which is not yet created, is accessed according to node request 291, the data of the node is retrieved from the intermediate document 260 and DOM node 297 may be created and be added to deferred DOM document 299. Accordingly, such behavior allows creating DOM documents quickly when big XML documents are parsed because a limited number of nodes are initially created, whereas the remaining nodes are created when they are accessed.

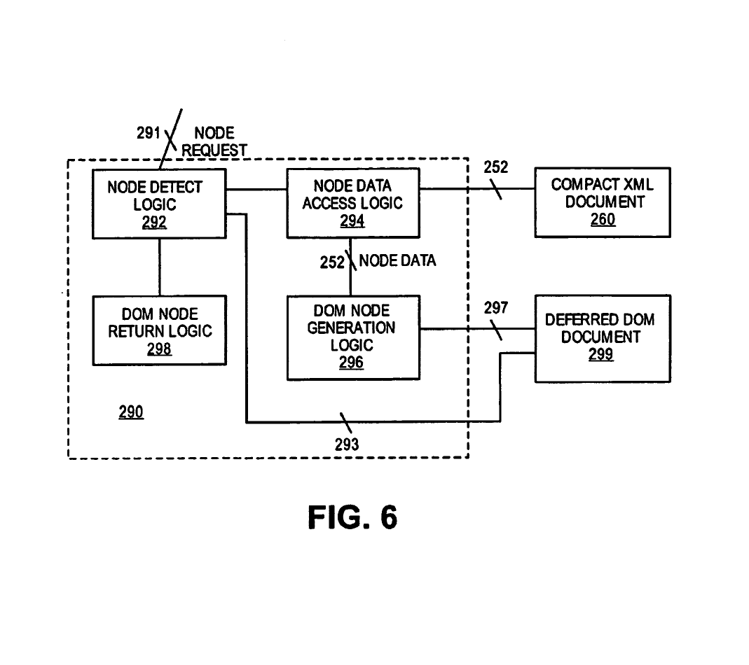

FIG. 6 is a block diagram further illustrating deferred DOM document builder logic 290 of FIG. 5, according to one embodiment. Representatively, deferred DOM builder logic 290 may include node detect logic 292, which may receive a node request 291 for a DOM node within deferred DOM document 299. In response to such request, in one embodiment, node detect logic 292 may access deferred DOM document 299 to determine whether the requested node 293 has been created. In one embodiment, when the requested node 293 has been created, DOM node return logic 298 simply returns the DOM node requested data 297. However, where the requested node has not yet been created within deferred DOM document 299, in one embodiment, node data access logic 294 will access node data 252 from intermediate document 260.

As described above, intermediate document 260 may be generated according to intermediate document builder logic 230 using, for example, an event-based parser, such as a SAX parser. As further shown in FIG. 6, in one embodiment, DOM node generation logic 296 generates a DOM node 297 within deferred DOM document 299. Accordingly, by deferring generation of DOM nodes within deferred DOM document 299 and limiting generation of such nodes to requested nodes, an amount of time required to generate a conventional DOM document 299 may be reduced. In one embodiment, the reduced memory requirements for generating deferred DOM document 299 may enable DOM functionality within an MPC system, including system 100, as shown in FIG. 1. Procedural methods for implementing one or more of the above described embodiments are now provided.

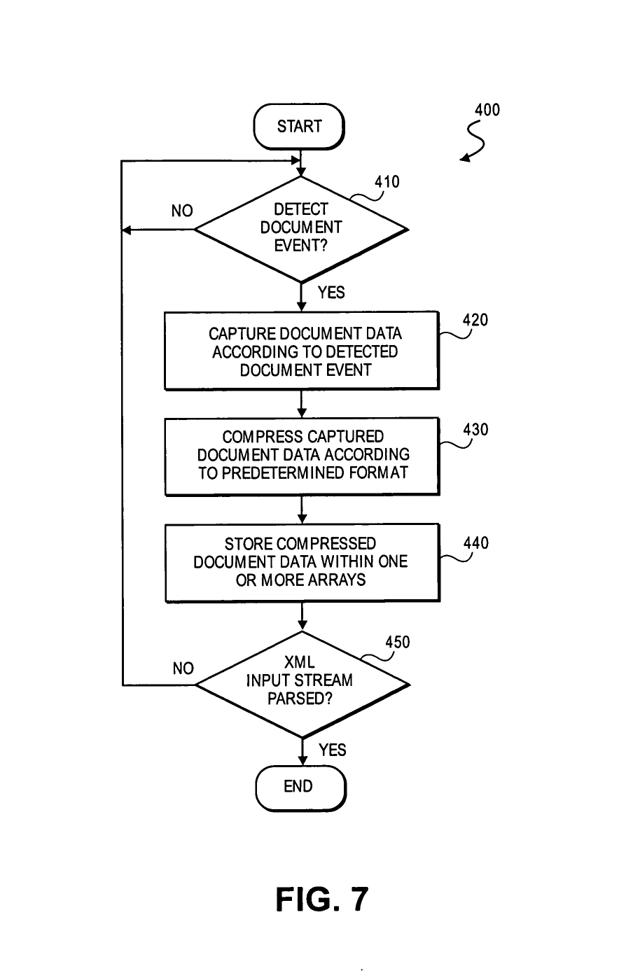

Turning now to FIG. 7, the particular methods associated with various embodiments are described in terms of computer software and hardware with reference to a flowchart. The methods to be performed by a computing device (e.g., a network interface controller) may constitute state machines or computer programs made up of computer-executable instructions. The computer-executable instructions may be written in a computer program and programming language or embodied in firmware logic. If written in a programming language conforming to a recognized standard, such instructions can be executed in a variety of hardware platforms and for interface to a variety of operating systems.

In addition, embodiments are not described with reference to any particular programming language. It will be appreciated that a variety of programming languages may be used to implement embodiments as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

FIG. 7 is a flowchart illustrating a method 400 for meeting compliance for generating a compact representation of an XML document, in accordance with one embodiment. In the embodiments described, examples of the described embodiments will be made with reference to FIGS. 1-6. However, the described embodiments should not be limited to the examples provided to limit the scope provided by the appended claims.

Referring again to FIG. 7, at process block 410, it is determined whether a document event is detected. As described above, document events may include SAX events including, but are not limited to start element events, end element events, the XML declaration event, character events, comment events, CDATA section events, the start DTD event, the end DTD event, processing instruction events, notation declaration events, external parsed entity declaration events, internal parsed entity declaration events, unparsed entity declaration events, start entity events and end entity events.

As further shown in FIG. 7, at process block 420, document data is captured according to the detected document event. In one embodiment, such capture of document data may be performed according to the pseudo-code provided in Tables 6-20, as illustrated above. At process block 430, the captured document data is compressed according to a predetermined format. In one embodiment, the predetermined format may be provided as shown in Table 3, which describes a packed format to provide a compact representation of an input XML document.

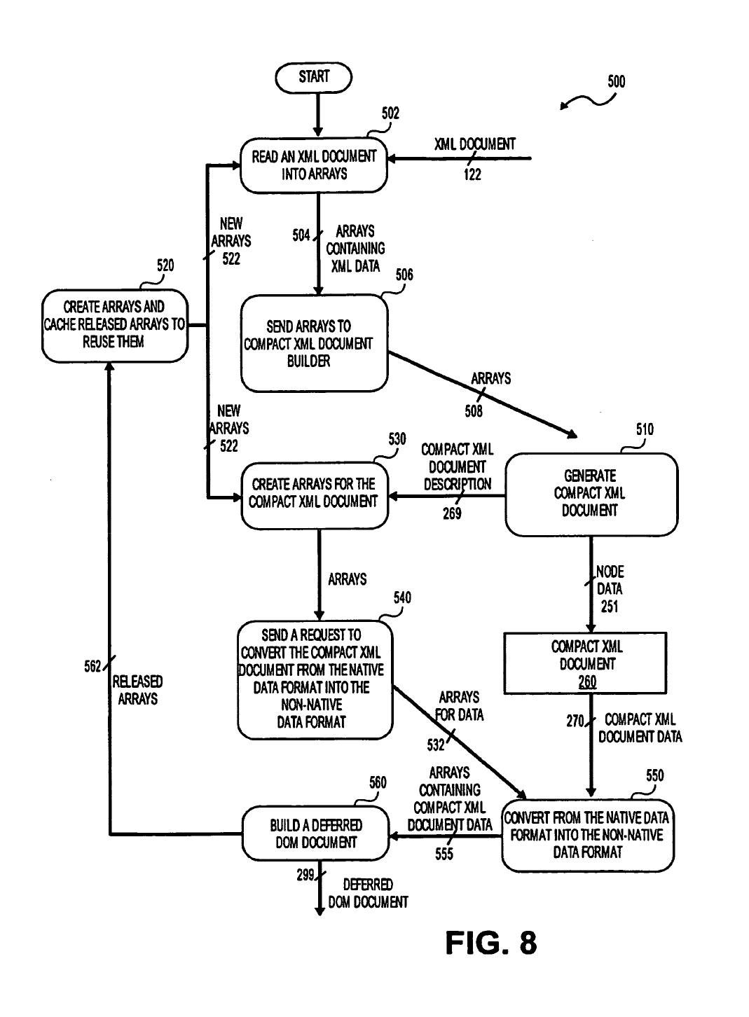

At process block 440, the compressed document data is stored within one or more arrays, for example, as shown in FIG. 4. Finally, at process block 450, this process is repeated until the XML input stream is completely parsed. In one embodiment, the intermediate representation provided by the flowchart and method 400 as shown in FIG. 7 may be provided to a DOM document builder to enable generation of a deferred DOM document, as described with reference to FIG. 8.

FIG. 8 is a flowchart illustrating a method 500 for generating a deferred DOM document, according to one embodiment. Representatively, at process block 502, an input XML document 122 is read into arrays. Subsequently, arrays containing XML data 504 are received at process block 506 and sent to an intermediate document builder. At process block 510, an intermediate document may be generated according to received arrays 508. In one embodiment, generation of the intermediate document includes node data 252 for intermediate document 260.

At process block 530, arrays are created for the intermediate document according to a received intermediate document description 269. At process block 540, a request to convert the intermediate document from a native document format into a non-native document format is performed at process block 540. Accordingly, at process block 550, the intermediate document data is converted from the native document data format into a non-native data format. Finally, at process block 560, a deferred DOM document 299 is generated according to received arrays containing intermediate document data 555.

In one embodiment, as described herein, the Java context is an execution context inside a Java virtual machine (JVM). Conversely, the native context is an execution context outside the JVM. In one embodiment, the native context allows optimizing an application for a desired platform processor. Performance of the implementations that have components residing in both contexts depends on how data transition between the native context and non-native context is effected.

In one embodiment, the compact representation of an XML document effectively uses memory and allows navigating through parsed XML documents. Depending on an XML document, the representation can use memory that is 0.7-1.2 of the size of the XML document. Accordingly, in one embodiment, the compact representation enables use of XML documents in memory restricted requirements, such as, mobile phones, PDAs and other like battery-powered devices. In one embodiment, generation of node data within the intermediate representation enables forward iteration for access to parsed content of an input XML document according to an object-granulated format.

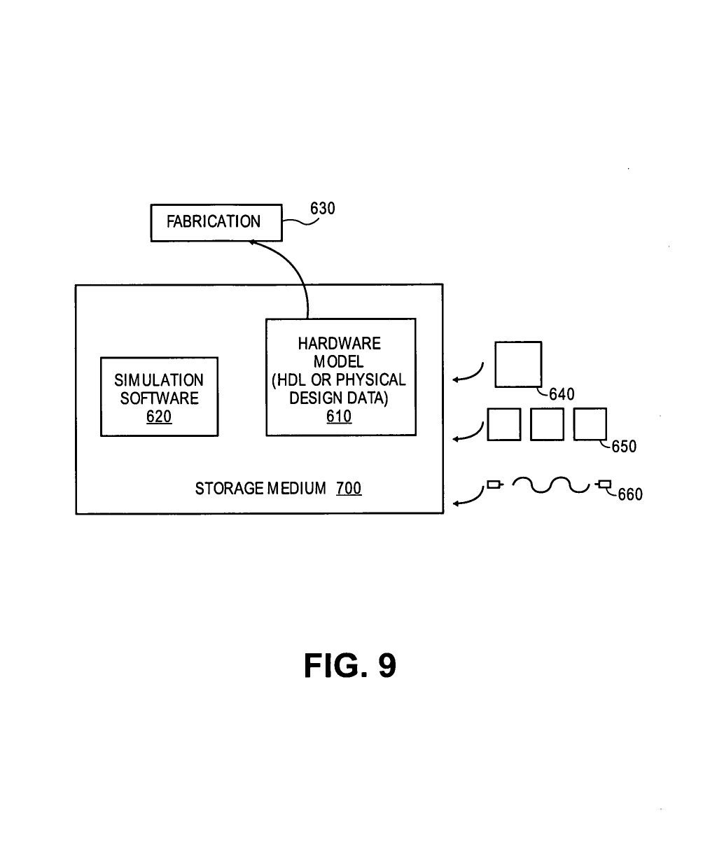

FIG. 9 is a block diagram illustrating various representations or formats for simulation, emulation and fabrication of a design using the disclosed techniques. Data representing a design may represent the design in a number of manners. First, as is useful in simulations, the hardware may be represented using a hardware description language, or another functional description language, which essentially provides a computerized model of how the designed hardware is expected to perform. The hardware model 610 may be stored in a storage medium 600, such as a computer memory, so that the model may be simulated using simulation software 620 that applies a particular test suite 630 to the hardware model to determine if it indeed functions as intended. In some embodiments, the simulation software is not recorded, captured or contained in the medium.

Additionally, a circuit level model with logic and/or transistor gates may be produced at some stages of the design process. The model may be similarly simulated some times by dedicated hardware simulators that form the model using programmable logic. This type of simulation taken a degree further may be an emulation technique. In any case, reconfigurable hardware is another embodiment that may involve a machine readable medium storing a model employing the disclosed techniques.

Furthermore, most designs at some stage reach a level of data representing the physical placements of various devices in the hardware model. In the case where conventional semiconductor fabrication techniques are used, the data representing the hardware model may be data specifying the presence or absence of various features on different mask layers or masks used to produce the integrated circuit. Again, this data representing the integrated circuit embodies the techniques disclosed in that the circuitry logic and the data can be simulated or fabricated to perform these techniques.

In any representation of the design, the data may be stored in any form of a machine readable medium. An optical or electrical wave 660 modulated or otherwise generated to transport such information, a memory 650 or a magnetic or optical storage 640, such as a disk, may be the machine readable medium. Any of these mediums may carry the design information. The term “carry” (e.g., a machine readable medium carrying information) thus covers information stored on a storage device or information encoded or modulated into or onto a carrier wave. The set of bits describing the design or a particular of the design are (when embodied in a machine readable medium, such as a carrier or storage medium) an article that may be sealed in and out of itself, or used by others for further design or fabrication.

### Alternate Embodiments

It will be appreciated that, for other embodiments, a different system configuration may be used. For example, while the system 100 includes a single CPU 102, for other embodiments, a multiprocessor system (where one or more processors may be similar in configuration and operation to the CPU '02 described above) may benefit from the two micro-operation flow using source override of various embodiments. Further different type of system or different type of computer system such as, for example, a server, a workstation, a desktop computer system, a gaming system, an embedded computer system, a blade server, etc., may be used for other embodiments.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments described may be downloaded as a computer program which may be transferred from a remote computer (e.g., a server) to a requesting computer (e.g., a client) by way of data signals embodied in a carrier wave or

1. A method comprising:
providing extensible mark-up language (XML) document data of an input XML document to a parser,
generating compact XML document representation of the input XML document according to document events received from the parser; and
compressing, during the generating of the compact XML document representation components of the XML document according to a predetermined format to form a compact representation of the XML document for access to parsed content of the input XML document.
condensing, during the generating of the compact XML document representation, character data from the XML document data to form a compact, representation of the XML document for access to parsed content of the input XML document.

2. The method of claim 1, further comprising:
providing the compact XML document as an intermediate document to a deferred document object model (DOM) document builder to enable generation of a deferred DOM document and
generating a deferred document object model (DOM) document according to the intermediate document.

3. The method of claim 1, wherein generating the compact XML document representation comprises:
packing data from elements, text, CDATA section, comments, processing instructions, document type definition(DTD) and entity references from the input XML document into an array of nodes according to a predetermined format;
storing names of elements, attributes, notations, DTD, entities and processing instructions in the array names:
storing namespace URIs used in namespaces declarations in the array of namespace URIs:
storing character data of the input XML document in the array of character data:
storing information of external IDs in the array of external IDs:
storing information of notation declarations in the array of notations:
storing information of entity declarations in the array of entities:
storing information of attributes of elements in the array of attributes:
storing information about children of elements and entity references in the array of nodes:
storing information about attributes of elements in the array of nodes, and storing information about -the next sibling of elements, entity references, text, CDATA sections, comments, processing instructions and DTD in the array of nodes.

4. The method of claim 1, wherein condensing the character data further comprises:
copying data of a name if the name does not exist in the array of names;
restricting copying data of namespace URIs to data of namespace URIs that are not contained in the array of namespace URIs;
copying data of an external ID if the external ID does not exist in the array of external IDs.

5. The method of claim 4, further comprising:
restricting copying content of some text nodes into the character data array to data of text nodes that have not previously occurred.

6. The method of claim 5, further comprising:
detecting text node data that matches string templates including a user specified template;
determining whether data of the text node is previously detected; and
using a reference to the content of the text node if the text node is previously detected.

7. (canceled)

8. The method of claim 1, wherein generating the deferred DOM document further comprises:
generating a pre-parsed intermediate representation of the input XML document:
generating a deferred DOM document, including a reduced number of nodes;
receiving an access request for a node of the deferred DOM document that is not yet created;
accessing node data of the requested node from the compact, intermediate representation; and
generating the requested node within the deferred DOM document.

9. (canceled)

10. (canceled)

11. The method of claim 7, wherein the compact XML document representation provides forward iteration over the parsed content of the input XML document in an object granulated format.

12. An article of manufacture having a machine accessible medium including associated data, wherein the data, when accessed, results in the machine performing operations comprising:
generating an compact XML representation of an input extensible mark-up language (XML) document according to document events received from a parser;
compressing, during the generating of the intermediate representation, components of the XML document according to a predetermined format to form a compact intermediate representation of the XML document for access to parsed content of the input XML document; and
deferring generation of at least one node of a deferred document object mode (DOM) document until the node is requested, the requested node generated according to node data of the compact intermediate representation.

13. The article of manufacture of claim 12, wherein the operation of compressing components of the XML document further results in the machine performing operations comprising:
detecting text node data that matches a user specified template;
determining whether the text node data is previously detected; and
storing a reference to content of the text node data if the text node data is previously detected.

14. The article of manufacture of claim 12, wherein the operation of deferring generation of the node further results in the machine performing operations comprising:
generating a deferred DOM document, including a reduced number of nodes;
receiving an access request for a node of the deferred DOM document that is not yet created;
accessing node data of the node from the compact, intermediate representation; and
generating the node within the deferred DOM document.

15. The article of manufacture of claim 12, wherein the operation of deferring generation of the node further results in the machine performing operations comprising:
generating a pre-parsed intermediate representation of the input XML document;
receiving an access request for a node;
parsing the intermediate representation of the requested node; and
creating the requested node within the deferred DOM document.

16. A system comprising:
a processor;
a chipset coupled to the processor, the chipset including compact XML document builder logic to generate a compact representation of an input extended mark-up language (XML) document for access to parsed content of the input XML document and deferred document creation logic to defer generation of at least one node of a deferred document object model (DOM) document until the node is accessed, where the node is generated according to node data from the parsed content of the compact representation of the input XML document; and
a battery to power the chipset and the processor.

17. The system of claim 16, wherein the compact XML document builder logic further comprises:
data compression logic to compress, during generation of the compact XML document representation, components of the XML document according to a predetermined format to form the compact representation of the XML document for access to parsed content of the input XML document.

18. The system of claim 16, wherein the data compression logic is further to condense, during the generation of the intermediate representation, character data from the XML document data to form the compact representation of the XML document for access to parsed content of the XML document.

19. The system of claim 16, wherein the deferred DOM document creation logic is further to generate a pre-parsed intermediate representation of the input XML document, parsing the intermediate representation of a request node, and create the requested node within the deferred DOM document.

20. The system of claim 16, wherein the chipset further comprises:
a network interface controller to couple a network to the chipset to receive the input XML document.

21. A method comprising:
generating an intermediate representation for access to parsed content of an input extensible mark-up language (XML) document;
compressing, during the generating of the intermediate representation, components of the XML document according to a predetermined format to form a compact intermediate representation of the XML document for access to parsed content of the input XML document; and
generating a deferred document object model (DOM) document according to the intermediate representation.

22. The method of claim 21, wherein generating the deferred DOM document further comprises:
generating a pre-parsed intermediate representation of the input XML document;
receiving an access request for a node;
parsing the intermediate representation of the node; and
creating the requested node within the deferred DOM document.

23. The method of claim 21, wherein compressing components of the XML document further comprises:
condensing, during the generating of the intermediate representation, character data from the XML document data to form the compact intermediate representation of the XML document for access to parsed content of the XML document.
